(19) United States
(12) Patent Application Publication
(10) Pub. No.: US 2006/0132397 A1
(43) Pub. Date: Jun. 22, 2006

(54) Organic electroluminescence display device

(75) Inventors: Cheon Hong Kim, Seoul (KR); Se Jong Yoo, Kyoungki-do (KR)

Correspondence Address: SEYFARTH SHAW LLP, 55 E. MONROE STREET, SUITE 4200, CHICAGO, IL, 60603-5803, US

(73) Assignee: Boe Hydis Technology Co., Ltd.

(21) Appl. No.: 11/243,761

(22) Filed: Oct. 5, 2005

(30) Foreign Application Priority Data
Dec. 22, 2004 (KR) 10-2004-0110366

(51) Int. Cl. G09G 3/30

(52) U.S. Cl. 345/76

(57) ABSTRACT

Disclosed is an organic electroluminescence display device which can prevent the degradation of image quality and the property deterioration of a transistor provided in each pixel. The organic electroluminescence display device comprises: a plurality of data lines for transmitting a data signal; a plurality of gate lines intersecting the data lines and transmitting a gate signal; and a plurality of pixels formed by the data lines and the gate lines, wherein, each of the pixels comprising: a transistor including a gate terminal connected to one of the data lines and a drain terminal connected to one of the gate lines; and an organic light emitting means for emitting light according to amount of electric current flowing through a source terminal of the transistor.

### BACKGROUND OF THE INVENTION

1. Field of the Invention

The present invention relates to an organic electroluminescence display device, and more particularly to an organic electroluminescence display device which can prevent the degradation of image quality and the property deterioration of a transistor provided in each pixel.

2. Description of the Prior Art

Recently, liquid crystal display devices have been developed to be used as a replacement for cathode ray tubes (CRTs) and the usage thereof has gradually increased. Since the liquid crystal display device is a device which cannot emit light for itself, it requires a separate light source, thereby causing high power consumption and having a limitation in reducing the thickness thereof. In addition, since the liquid crystal display device obtains image signals through the reaction of liquid crystal, the liquid crystal display device has a limitation in displaying high-speed moving pictures due to the time required for response of the liquid crystal. There also exists a limitation with the viewing angle. As a display device for replacing such a liquid crystal display device, an organic electroluminescence display device has being developed. Such an organic electroluminescence display device uses a light emission phenomenon occurring when an electric field is applied to a specific organic or polymer substance.

Hereinafter, an organic electroluminescence display device will be described with reference to FIG. 1.

FIG. 1 is a block diagram schematically illustrating an organic electroluminescence display device.

The organic electroluminescence display device includes a panel 11, a gate driver 12 connected to the panel 11, a data driver 13 connected to the panel 11, a timing control unit 14 for controlling the drivers 12 and 13. The panel 11 includes a plurality of gate lines G₁, G₂, . . . , Gₘ₋₁, and Gₘ aligned parallel, and a plurality of data lines D₁, D₂, . . . , Dₙ₋₁ and Dₙ intersecting the gate lines G₁, G₂, . . . , Gₘ₋₁, and Gₘ. Each region surrounded by the gate lines G₁, G₂, . . . , Gₘ₋₁, and Gₘ and data lines D₁, D₂, . . . , Dₙ₋₁ and Dₙ, which are aligned in a matrix pattern, forms a unit pixel.

FIG. 2 is a circuit diagram illustrating a pixel in the conventional organic electroluminescence display device, and FIG. 3 is a waveform diagram illustrating an operation of the pixel during one frame period.

According to the conventional organic electroluminescence display device, each pixel includes a switching transistor T1, a capacitor C, a driving transistor T2 and an organic light emitting diode OLED1.

A drain terminal of the switching transistor T1 is connected to a data line D and a gate terminal thereof is connected to a gate line G. The switching transistor T1 is turned on/off by a gate signal ‘gate1’ applied to the gate line G. When the switching transistor T1 is turned on, the switching transistor T1 delivers a data signal ‘data 1’, which is transmitted from the data line D, to the capacitor C and the driving transistor T2. The capacitor C is connected to a terminal of an exterior voltage source Vdd and maintains the data signal ‘data 1’ during one frame period. A gate terminal of the driving transistor T2 is connected to both a source terminal of the switching transistor T1 and the capacitor C, and a drain terminal of the driving transistor T2 is connected to the exterior voltage source Vdd. The driving transistor T2 is turned on/off by a data signal applied from the switching transistor T1 and a data signal charged in the capacitor C, that is, by a data signal ‘data2’ of a common connection terminal P. When the driving transistor T2 is turned on by the data signal ‘data2’, the driving transistor T2 transmits electric current of the exterior voltage source Vdd to the organic light emitting diode OLED1 while controlling the amount of the electric current. As a result, the organic light emitting diode OLED1 emits light I1, the intensity of which is proportional to the amount of the electric current i1 transmitted to the organic light emitting diode OLED1. Herein, an anode of the organic light emitting diode OLED1 is connected to a source terminal of the driving transistor T2, and a cathode of the organic light emitting diode OLED1 is connected to a common cathode terminal Vca.

According to the conventional organic electroluminescence display device, when a pixel is turned on by a gate signal ‘gate1’, the driving transistor T2 provided in the pixel is maintained in a turn-on state during one frame period, owing to a data signal ‘data2’ of the common connection terminal P between the switching transistor T1 and the capacitor C, thereby continuously applying the electric current i1 to the organic light emitting diode OLED1. Accordingly, the property of the driving transistor T2 is deteriorated to change the threshold voltage Vth of the driving transistor T2. Such a change in the threshold voltage also changes the output electric current of the driving transistor T2, so that the uniformity of light I1 emitted from the organic light emitting diode OLED1 deteriorates and, thus, the quality of the image deteriorates. Consequently, the life span of the organic light emitting diode OLED1 is shortened, thereby reducing the life span of the organic electroluminescence display device.

Also, according to the conventional organic electroluminescence display device, a data signal ‘data1’ is continuously applied to each pixel through the data line D, and the organic light emitting diode OLED1 of each pixel continuously emits light by the applied data signal, so that an image corresponding to an image signal is continuously displayed. Therefore, the user perceives the mean luminosity between those of successive first and second frames, so that the display screen may be perceived as blurred. Such a phenomenon becomes more severe when a higher-speed moving picture is played.

To solve such problems, a technique for compensating for the property deterioration of the transistor by increasing the number of transistors has been proposed. However, such increase in the number of transistors decreases an aperture ratio, thereby complicating the structure of each pixel.

### SUMMARY OF THE INVENTION

Accordingly, the present invention has been made to solve the above-mentioned problems occurring in the conventional organic electroluminescence display device, and an object of the present invention is to provide an organic electroluminescence display device which can prevent the property deterioration of a driving transistor provided in each pixel, thereby extending the life span of the organic electroluminescence display device and improving image quality.

In order to accomplish this object, there is provided an organic electroluminescence display device comprising: a plurality of data lines for transmitting a data signal; a plurality of gate lines intersecting the data lines and transmitting a gate signal; and a plurality of pixels formed by the data lines and the gate lines, wherein, each of the pixels comprising: a transistor including a gate terminal connected to one of the data lines and a drain terminal connected to one of the gate lines; and an organic light emitting means for emitting light according to amount of electric current flowing through a source terminal of the transistor.

In accordance with another aspect of the present invention, the amount of electric current flowing through the source terminal of the transistor is determined by a voltage level which is applied to the gate terminal of the transistor through the data line.

In accordance with still another aspect of the present invention, a first voltage and a second voltage are applied to the drain terminal of the transistor through the gate line, and electric current flows through the source terminal of the transistor when the first voltage is applied to the drain terminal thereof, and no electric current flows through the source terminal of the transistor when the second voltage is applied to the drain terminal thereof.

In accordance with still another aspect of the present invention, the first voltage has a lower voltage level than that of a threshold voltage level of the transistor.

In accordance with still another aspect of the present invention, the second voltage has a higher voltage level than a voltage level difference between the threshold voltage and a voltage applied to the gate terminal of the transistor.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an organic electroluminescence display device;

FIG. 2 is a circuit diagram illustrating a pixel in the conventional organic electroluminescence display device;

FIG. 3 is a waveform diagram illustrating an operation of a pixel shown in FIG. 2;

FIG. 4 is a circuit diagram illustrating a construction of a pixel in an organic electroluminescence display device according to an embodiment of the present invention; and

FIG. 5 is a waveform diagram illustrating an operation of a pixel shown in FIG. 4.

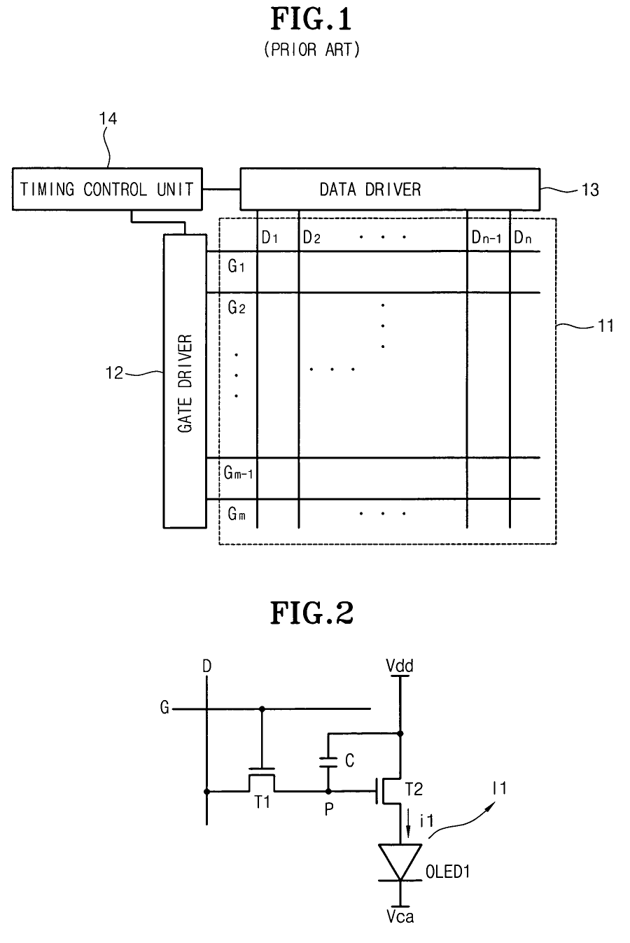

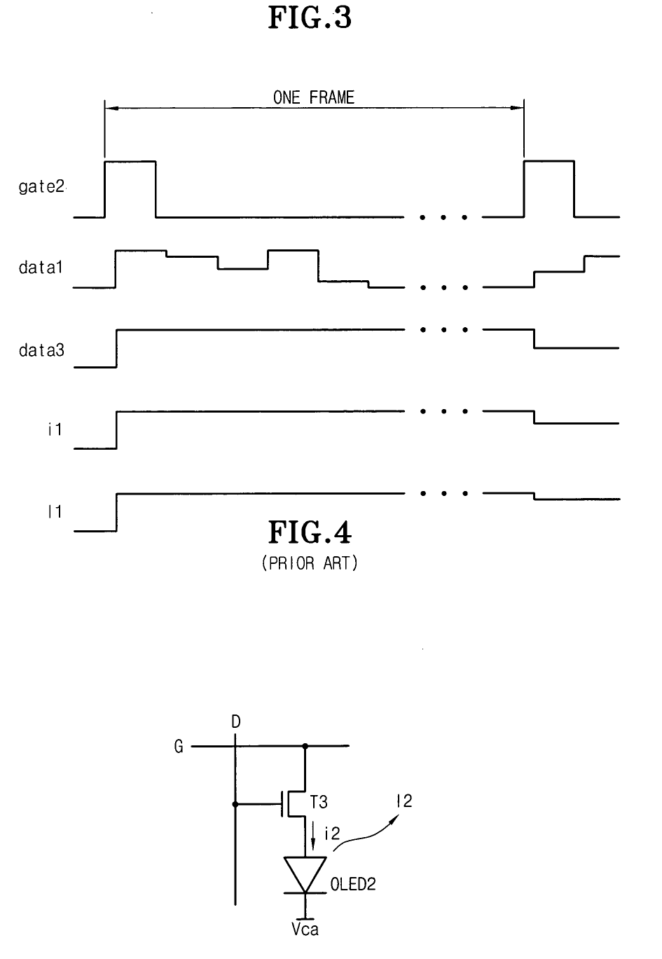

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

FIG. 4 is a circuit diagram illustrating a construction of a pixel in an organic electroluminescence display device according to an embodiment of the present invention.

According to an embodiment of the present invention, each pixel of the organic electroluminescence display device includes a driving transistor T3 and an organic light emitting diode OLED2. A gate terminal of the driving transistor T3 is connected to a data line D, and a drain terminal thereof is connected to a gate line G. A source terminal of the driving transistor T3 is connected to the organic light emitting diode OLED2. An anode of the organic light emitting diode OLED2 is connected to the source terminal of the driving transistor T3, and a cathode thereof is connected to a common cathode terminal Vca.

According to the organic electroluminescence display device of an embodiment of the present invention, when a voltage of a predetermined level is applied to the drain terminal thereof by a gate signal ‘gate2’ applied through the gate line G, the driving transistor T3 is turned on. When the driving transistor T3 is turned on as described above, a data voltage is applied to the gate terminal G by a data signal ‘data3’ applied through the data line D. The applied data voltage changes the amount of electric current i2 flowing through the source terminal of the driving transistor T3. Then, the electric current i2 flowing through the source terminal is transmitted to the organic light emitting diode OLED2, so that the organic light emitting diode OLED2 emits light I2, the intensity of which is proportional to the amount of electric current i2 flowing through the source terminal of the driving transistor T3.

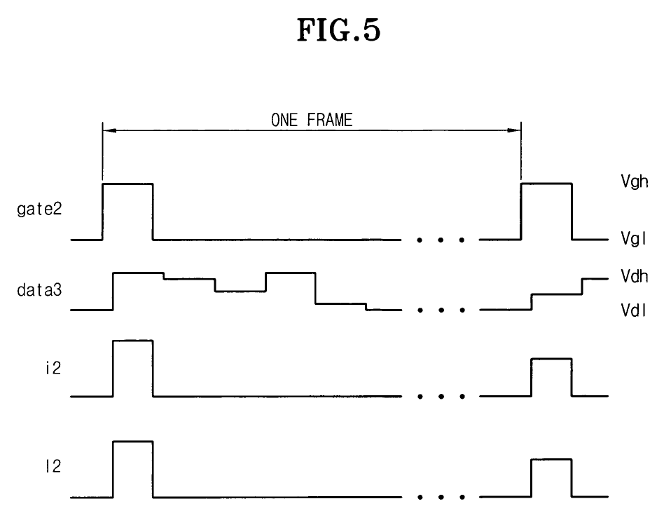

Hereinafter, the operation of each pixel in the organic electroluminescence display device according to an embodiment of the present invention will be described with reference to FIG. 5.

A gate signal ‘gate2’ is applied to the drain terminal of the driving transistor T3 through the gate line G, and a data signal ‘data3’ is applied to the gate terminal of the driving transistor T3 through the data line D. The gate signal ‘gate2’ has one of a first voltage Vgl and a second voltage Vgh. The data signal ‘data3’ has a voltage level between a third voltage Vdl and a fourth voltage Vdh. When the gate signal ‘gate2’ has the level of the second voltage Vgh, the second voltage Vgh is applied to the drain terminal of the driving transistor T3, so that the driving transistor T3 is turned on. Then, the amount of electric current i2 flowing through the source terminal of the driving transistor T3 is determined according to the voltage level of the data signal ‘data3’ applied to the gate terminal of the driving transistor T3. In this case, the second voltage Vgh has a value satisfying the following condition so that the driving transistor T3 may operate in a saturation state:
Vgh≧Vdh−Vth.

Herein, ‘Vth’ represents a threshold voltage of the driving transistor T3.

When the driving transistor T3 operates in a saturation state as described above, the amount of electric current i2 flowing through the source terminal of the driving transistor T3 is determined by the following equation:

$$i 2 = \frac{k \times Cg \times W \times {( Vgs - Vth )}^{2}}{2 L} .$$

Herein, ‘k’ represents the mobility of a carrier in the driving transistor T3, ‘Cg’ represents the capacitance of a gate insulating layer in the driving transistor T3, ‘W’ represents the channel width of the driving transistor T3, ‘L’ represents the channel length of the driving transistor T3, and ‘Vgs’ represents a voltage between the gate terminal and the source terminal in the driving transistor T3.

A voltage level applied to the gate terminal of the driving transistor T3 changes depending on the data signal ‘data3’, and the value of ‘Vgs’ in the equation is determined by the data signal ‘data3’. Therefore, the amount of electric current i2 flowing through the source terminal of the driving transistor T3 is determined by the data signal ‘data3’. The electric current i2, the amount of which has been determined by the data signal ‘data3’ as described above, is applied to the organic light emitting diode OLED2. That is, the organic light emitting diode OLED2 emits light I2, the intensity of which is proportional to the amount of electric current i2 changed depending on the data signal ‘data3’.

When the gate signal ‘gate2’ changes from the second voltage Vgh to the first voltage Vgl, the driving transistor T3 is turned off, so that the electric current flowing through the source terminal of the driving transistor T3 is cut off. As a result, since no electric current i2 is applied to the organic light emitting diode OLED2, the organic light emitting diode OLED2 emits no light I2.

After each pixel has operated during one frame period as described above, the data signal ‘data3’ for the next frame has the level of the third voltage Vdl before being applied. Herein, the third voltage Vdl refers to a lower voltage level than the threshold voltage Vth of the driving transistor T3. In a section in which the data signal ‘data3’ has the level of the third voltage Vdl, the driving transistor T3 is completely turned off. As a result, the organic electroluminescence display device has a black pattern.

As described above, according to the organic electroluminescence display device of an embodiment of the present invention, each pixel includes only one driving transistor T3 and one organic light emitting diode OLED2, so that the construction of each pixel is simplified. The gate signal ‘gate2’ supplied through the gate line G is applied to drain terminal of the driving transistor T3, thereby turning on/off the driving transistor T3. Also, the data signal ‘data3’ supplied through the data line D is applied to the gate terminal of the driving transistor T3 to change the gate voltage level of the driving transistor T3, thereby determining the amount of electric current i2 flowing through the source terminal of the driving transistor T3. That is, the amount of electric current i2 delivered to the organic light emitting diode OLED2 is determined by the data signal ‘data3’, and the organic light emitting diode OLED2 emits light I2, the intensity of which is proportional to the amount of electric current i2. There are periods during which the driving transistor T3 is turned on and off by the gate signal ‘gate2’ and data signal ‘data3’. Therefore, the property deterioration of the driving transistor T3 can be prevented. Also, there is a black pattern section in the driving transistor's turning-off period because the organic light emitting diode OLED2 does not emit light I2 in that period.

According to the construction of an embodiment of the present invention, a gate signal is applied to a drain terminal of a driving transistor and a data signal is applied to a gate terminal of the driving transistor, so that it is possible to prevent the property of the driving transistor from deterioration. As a result, the life span of the organic electroluminescence display device can be extended. In addition, by preventing property deterioration and through the black pattern in the organic light emitting diode, the image quality of the organic electroluminescence display device can be improved.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An organic electroluminescence display device comprising:
a plurality of data lines for transmitting a data signal;
a plurality of gate lines intersecting the data lines and transmitting a gate signal; and
a plurality of pixels formed by the data lines and the gate lines, wherein,
each of the pixels comprising:
a transistor including a gate terminal connected to one of the data lines and a drain terminal connected to one of the gate lines; and
an organic light emitting means for emitting light according to amount of electric current flowing through a source terminal of the transistor.

2. The organic electroluminescence display device as claimed in claim 1, wherein the amount of electric current flowing through the source terminal of the transistor is determined by a voltage level which is applied to the gate terminal of the transistor through the data line.

3. The organic electroluminescence display device as claimed in claim 2, wherein a first voltage and a second voltage are applied to the drain terminal of the transistor through the gate line, and electric current flows through the source terminal of the transistor when the first voltage is applied to the drain terminal thereof, and no electric current flows through the source terminal of the transistor when the second voltage is applied to the drain terminal thereof.

4. The organic electroluminescence display device as claimed in claim 3, wherein the first voltage has a lower voltage level than that of a threshold voltage level of the transistor.

5. The organic electroluminescence display device as claimed in claim 3, wherein the second voltage has a higher voltage level than a voltage level difference between the threshold voltage and a voltage applied to the gate terminal of the transistor.
